(19) United States
(12) Patent Application Publication
(10) Pub. No.: US 2006/0037919 A1
(43) Pub. Date: Feb. 23, 2006

(54) Diesel fuel filter and associated methods

(76) Inventors: Agustin Lara, South Ogden, UT (US); Alicia Lara, South Ogden, UT (US)

Correspondence Address: Zachary Miles, Esq, 4072 Skyline Drive, Ogden, UT, 84403, US

(21) Appl. No.: 11/206,193

(22) Filed: Aug. 17, 2005

Related U.S. Application Data
(60) Provisional application No. 60/602,527, filed on Aug. 18, 2004.

(51) Int. Cl. B01D 25/12

(52) U.S. Cl. 210/805; 210/224; 210/259; 210/416.4

(57) ABSTRACT

A fuel filtration device for the corrective and preventive maintenance of fuel and fuel containers. An inlet tube removes fuel and particles from a fuel container passing the fuel and particulates through a pre-filter that removes particles greater than ½ cm. Fuel then enters a filter press that removes the remaining contaminants less than ½ cm in size. Filtered fuel returning to the container agitates the remaining fuel and loosens particles within the container. The loosened particulates and fuel are removed and filtered.

### CROSS-REFERENCE TO RELATED APPLICATIONS

This application claims the benefit of U.S. Provisional Patent Application No. U.S. Ser. No. 60/602,527, filed Aug. 18, 2004, the entirety of which is incorporated herein by reference.

### FIELD OF THE INVENTION

The present invention relates to techniques and devices for cleaning and maintaining diesel fuel and diesel fuel containers. Accordingly, the present invention involves the fields of chemistry, material science, and engineering.

### BACKGROUND OF THE INVENTION

Diesel fuel and diesel fuel containers must be cleaned and maintained to avoid costly repairs and decreased performance. Due to the increasing costs of diesel fuel, there is a great need to identify and develop new and suitable forms of fuel filtration and tank cleansing to increase the durability, performance, and life of machines powered by diesel fuel. In particular, water, solids, bacteria, and other contaminates and impurities must be removed from the fuel and fuel container.

Current techniques for the removal of contaminants may require removing the fuel from the container, cleaning the container, and replacing the fuel. Additionally, the container may need to be removed from the engine or machine, cleaned, and then replaced. These techniques are expensive and time consuming.

Therefore, devices and methods that improve the efficiency, safety, and quality of filtering diesel fuel and cleaning diesel fuel containers while maintaining the integrity of the fuel and fuel container would be a significant advancement in the area of diesel fuel filtration and fuel tank cleansing.

### SUMMARY OF THE INVENTION

In accordance with the present invention, a device and method for filtering fuel and maintaining and cleaning the fuel container without having to remove the container is presented. The filtration device contains features which, in addition to making the machine easier to use and transport, improves efficacy, safety, and performance.

In one preferred embodiment of the present invention, by way of a transfer pump, the fuel within a container is removed therefrom through an extendable inlet hose, passed through a pre-filter, sensor, ozone chamber, and a filter press comprising a set of plates to remove micro-contaminants. Micro-paper, which removes the smaller particulates and contaminants from the fuel, is inserted between the plates.

The filter press has a tightening device whereby the plates are pressed together to hold the micro-paper in place and to remove any excess fuel from the micro-paper. Several plates and pieces of micro-paper may be inserted before the tightening device is actuated. The fuel is passed through the tightened plates and micro-paper before exiting the filter press. The tightening device may be loosened to remove or add plates to the filter press.

Once the fuel has passed through the filter press, the filtered fuel exits the device through a second extendable outlet hose that leads the diesel fuel back into the fuel container. The fuel entering the container creates a turbid action that loosens contaminants within the container. These loosened contaminants are then removed and filtered out by the present invention.

In another aspect of the present invention, a pressure valve releases fuel into an overflow tank when pressure within the filter press reaches levels beyond the optimal operating range. The overflow fuel enters an overflow filter that removes larger contaminants. The fuel is then returned to the filter press for further filtering.

There has thus been outlined various features of the invention so that the detailed description thereof that follows may be better understood, and so that the present contribution to the art may be better appreciated. Other features and advantages of the present invention will be apparent from the following detailed description of the invention and corresponding drawings, taken with the accompanying claims, or may be learned by the practice of the invention.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 (FIG. 1) is an illustration of the basic machine structure in accordance with an embodiment of the present invention.

FIG. 2 (FIG. 2) is an illustration of the components of an embodiment in accordance with an embodiment of the present invention.

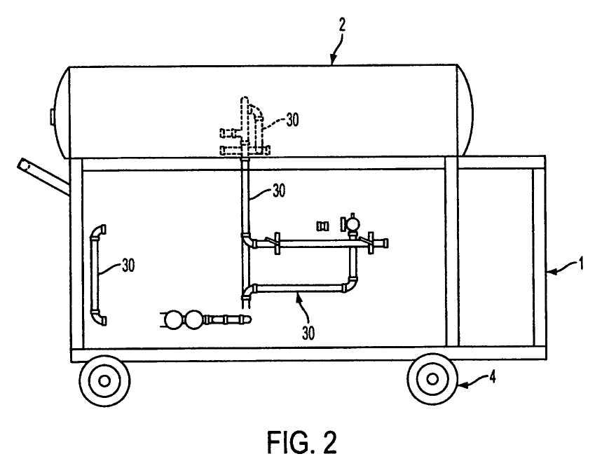

FIG. 3 (FIG. 3) is an illustration of the concave side of the filter press plates.

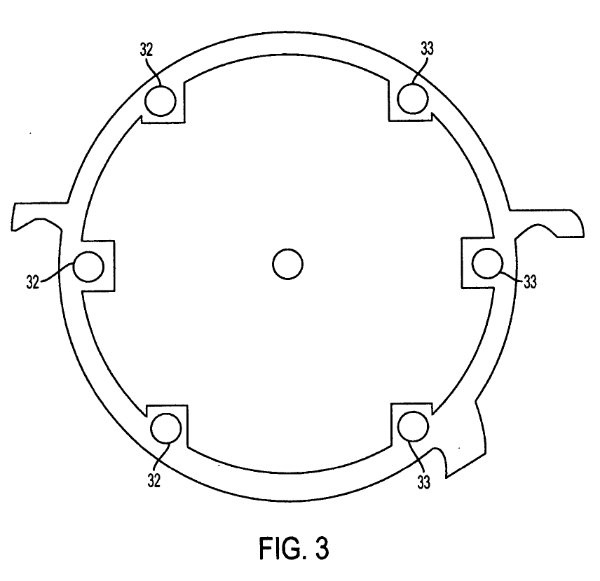

FIG. 4 (FIG. 4) is an illustration of the convex side of the filter press plate.

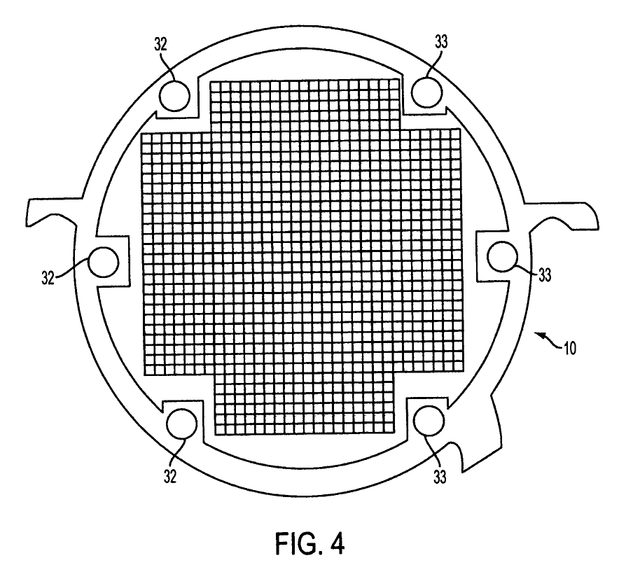

### DETAILED DESCRIPTION OF THE INVENTION

Before the present invention is disclosed and described, it is to be understood that this invention is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

As used in this specification and the appended claims, the singular forms a “an” and “the” include plural referents unless the content clearly dictates otherwise.

The term “about” when referring to a numerical value or range is intended to encompass the values resulting from experimental error that can occur when taking measurements.

The term “particle” refers to any impurity contained within, surrounding, or existing within the same tank or container as the fuel being filtered. Unless otherwise specified herein, a particle is not limited to size, shape, viscosity, density, or form.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

In accordance with embodiments of the present invention, a corrective and preventive filtration device 27 for fuel filtration and tank cleaning is described in detail. In a preferred embodiment of the present invention, an extendable inlet hose 1 of cylindrical, prismatic, conical, or other similar shape to form a hose-like structure, is placed within a container holding fuel that may contain contaminants including but not limited to liquids, water, organics, microorganisms, particles, solids, solutions, elements, and debris. In the preferred embodiment, the inlet hose 1 is made from flexible material such as metals or metal alloys, rubber, or plastics, or other resilient material that resists corrosion.

Preferably, the extendable inlet hose 1 is removably connected to a first storage spool 2 that allows for the storage of the inlet hose 1, and prevents interference from the inlet hose 1 with the operation of the filtration device 27.

Preferably, the fuel travels through the inlet hose 1 to pre-filter 3 that retains particles larger than ½ cm in diameter. The inlet hose is operably connected to the pre-filter and may be disconnected, for example, for cleaning purposes. It should be understood that the filtration device's 27 components, as described herein, may be removed for cleaning. In a preferred embodiment, the pre-filter 3 contains a mesh made of metal or metal alloys or other resilient material that retains, filters the ½ cm or greater particles. In an alternative embodiment, the pre-filter 3 contains a series of cylindrical, plate, sponge-like, or similar filter structure for retaining, filtering, the ½ cm particles. The filters contained within the pre-filter are removable.

The pre-filter 3 is preferably mounted in a substantially vertical alignment with the contaminants migrating toward the bottom of the pre-filter to a drain plug allowing for the pre-filter 3 to be drained in a controlled manner. Further, as the pre-filter 3 allows for removable filters, one may access the inner portions of the pre-filter 3 for cleaning or other purposes. The pre-filter 3, as well as the other components of the filtration device 27, is made from durable material including but not limited to metal or metal alloys. Alternatively, one or multiple sides of the pre-filter 3 may be made from Plexiglas or similar durable transparent material so that the contents of the pre-filter 3 may be monitored.

Optionally, pre-filtered fuel enters sensor 4 from the pre-filter 3. Sensor 4 monitors the fuel leaving the pre-filter and sends information to a control unit 13 about, but not limited to, solid content, humidity, and density.

In the preferred embodiment, the pre-filtered fuel enters ozone chamber 5 from the pre-filter 3 or sensor 4. Ozone chamber 5 produces ozone to kill microorganisms that are and produce contaminants as well as degrade the fuel. The fuel activates the chemical ozone chamber 5. Alternatively, the ozone chamber 5 may continuously produce ozone irrespective of fuel contact. Preferably, the ozone chamber 5 is positioned after the pre-filter 3 as unfiltered contaminates may clog the ozone chamber 5. In another embodiment, fuel that exits the filter press 8 enters the ozone chamber 3. An example of an appropriate ozone chamber 5 is the magnetic fuel conditioner, FM1200 from PERENNIAL MONITORING SYSTEMS, having at least a ¾″ port size.

In a preferred embodiment, a transfer pump 6 generates the necessary force to move fuel through the filtration device 27. Through a set of gears, the transfer pump 6 varies its pumping action, increasing or decreasing the force, depending upon the density and viscosity of the fuel and contaminates being transferred through the filtration device 27. Preferably, the transfer pump 6 is removably and operably connected to the ozone chamber 5 or pre-filter 3. At this stage the bacteria and contaminants larger than ½ cm in diameter have been removed and allow for the efficient transfer of the fuel as well as particles smaller than ½ cm in diameter through the remaining elements of the filtration device 27.

A motor 7 generates the power for the transfer pump 6. Preferably the motor 7 is one horsepower; however the horsepower may be greater; up to a 5 horsepower motor has been used in the preferred embodiment.

The pre-filtered fuel enters a filter press 8 from the transfer pump 6. The filter press has a first and second end. The first and second ends are removably attached to a filtration tank 19. A compressor 34 is removably attached to one end of the filter press. In a preferred embodiment, the filter press 8 has a series of at least two positioning rods 35. The filter press 8 has a series of filter press plates 10 that rest on the positioning rods 35 thus aligning and supporting the filter press plates 10. In another embodiment, filter press 8 may be enclosed within a chamber of sufficient size to allow the filter press plates 10 to be positioned without having positioning rods 35, Preferably, two sheets of micro paper are placed between the filter press plates 10; however, 1-5 sheets are operable. The micro-paper has a preferred porosity of 0.3 to ten microns. Depending upon the contaminants within the fuel, a larger or smaller porosity may be used. The micro-paper provides sufficient contact time to remove a majority of particles less than ½ cm in diameter. The micro-paper is preferably made from cellulose that is semi-elastic, but other porous material may be used as a micro-paper, including commercially available filter papers.

In the preferred embodiment, the filter press plate 10 has a series of channels, inlet channels 32 and outlet channels 33. The number of channels may vary in number, with a preferred number of 3 inlet channels 32 and 3 outlet channels 33. The inlet channels 32 allow the diesel fuel to travel between the filter press plates 10 and contact the micro-paper. The outlet channels 33 allow the filtered fuel to travel out of the filter press 8 without contacting the incoming fuel through the inlet channels 32. The inlet channels 32 and outlet channels 33 are positioned substantially opposite one another with the channels being grouped together, inlet channels 32 to inlet channels 32, and outlet channels 33 to outlet channels 33. The filter press plates 10 have a concave and convex side. The concave portion of the filter press plate 10 is positioned opposite the convex portion of an adjacent filter press plate 10 with the micro-paper placed in-between the convex and concave portions. In the preferred embodiment the convex portion is a series of raised pillars positioned as to resemble a waffle or grid structure. When the filter press plates 10 are compressed together, inlet channels 32 align with inlet channels 32 and outlet channels 33 align with outlet channels 33 and seal the respective channels so that fuel from the inlet channels 32 does not enter into outlet channels 33 and vice versa.

Backplate 31 completes the channel circuit by capping a series of filter press plates 10 and transitioning the flow of fuel from the inlet channels 32 to the outlet channels 33. Backplate 31 has a convex portion and substantially flat surface. The preferred embodiment of backplate 31 has a convex portion similar to the waffle or grid structure of the filter press plates 10. The flat surface of backplate 31 is positioned against the compressor 34.

In a preferred embodiment, compressor 34 is made of a screw mechanism and handle. Actuating the screw mechanism to turn in one direction places pressure on backplate 31 thus compressing the filter plates 10 within the filter press 8. Turning the screw mechanism in the opposite direction relieves the compression. Adjusting the compressor 34 allows the micro-paper to expand or contract depending upon the saturation of the micro-paper. Further, by compressing the filter press 8 by means of the compressor 34, excess fuel is removed from the filter press 8. The compressor 34 may also be automatic through use of a hydraulic, mechanical, or electrical system, or the like, or manual through uses of various tightening mechanisms; as way of example, ratchet system, manual hydraulic system, weight system, or the like.

In a preferred embodiment, a filtration tank 19 is divided into a first section and a second section by a stop plate 20. The first section contains the filter press 8. The second section is optional, and is used to contain any diesel fuel that spills over from the first section of the filtration tank 19.

Stop plate 20 is a substantially solid piece of non-corrosive resilient material that is removable or nonremovable and prevents diesel fuel from entering the second section of the filtration tank 19 unless the level of the fuel exceeds the height of the stop plate 20. The stop plate does not completely seal off the second side of the filtration tank 19 from the first side of the filtration tank 19.

Filtered fuel from the filter press 8 exits an extendable outlet hose 12 that is preferably cylindrical, prismatic, or conical. The extendable outlet hose 12 is made of a flexible material such as rubber or plastics, or other resilient material that resists corrosion such as metals or metal alloys. In a preferred embodiment of the present invention, the outlet hose 12 is attached, removably or non-removably, to a second storage spool 17 with characteristics similar to those of storage spool 2.

The agitation caused by the return of the fuel to the tank or container removes particles, contaminants, and solids from the inner surface of the tank or container thus providing an efficient way of removing the same from the tank.

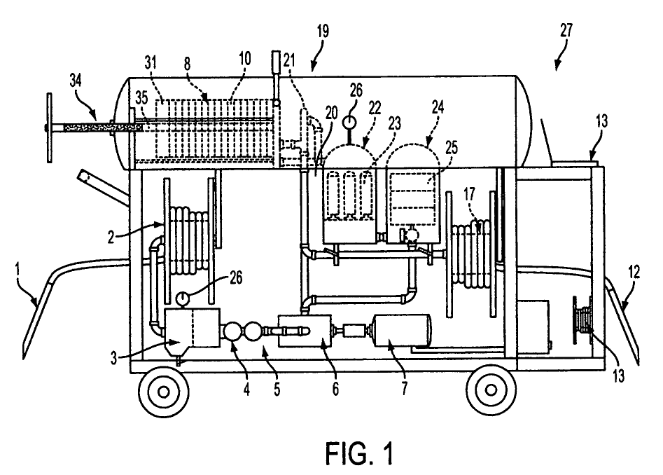

Referencing FIG. 1, a pressure valve 21 is operably positioned in the first section of the filtration tank 19 before fuel enters the filter press 8. The pressure valve 21 is closed when the pressure of the diesel fuel being pumped into the filter press is optimal. If the pressure rises above optimal, the pressure valve 21 opens and diesel fuel enters the first section of the filtration tank 19. By relieving pressure, damage does not occur to the components of the filtration device 27, and filtered fuel does not mix with unfiltered fuel.

Overflow fuel that is contained within the first or second section of the filtration tank 19 enters overflow filter 22 that contains at least one, preferably three removable tubular filters 23. Overflow filter 22 removes, by means of the tubular filters 23, any contaminants that may have been picked up by the overflow fuel within the first and second sections of filtration tank 19. Fuel exiting overflow filter 22 is directed back to the filter press 8 for further filtering.

In a preferred embodiment of the present invention, floater chamber 24 receives the fuel from overflow filter 22 and when floater chamber 24 is full, the floaters 25 contained within floater chamber 22 rotate thus opening a release valve at the bottom end of floater chamber 22 routing the fuel back into the filter press 8. the floaters are less dense than the diesel fuel, thus when the diesel fuel within the overflow filter 22 increases, the floaters try to buoy themselves and rotate.

In a preferred embodiment, monitoring gauges 26 are operatively attached to the pre-filter 3, filter press 8, and floater chamber 24. However, the monitors are not necessary in all of the positions or in any of the positions indicated. The monitoring gauges 26 communicate with the control unit 13, with monitoring, computational and storage capabilities to operate and control the machine, by relaying solid content, humidity, and density of the fuel for analysis by the control unit 13, and display of data. Control unit 13 may also be equipped to automatically shut down the filtration device 27 should any limitation or ranges of optimal operating range be exceeded. Additionally, the monitoring gauges 26 relay information to the control unit 13 about whether the filters are clogged and need to be removed and cleaned, temperature, pressure, and fuel flow.

The aforementioned components or elements of a preferred embodiment of the fuel filtration device 27 are operably connected with the use of pipes 30 that are made from metal, metal alloys, or semi-flexible material, for example, rubber or plastic. The pipes may be cylindrical, prismatic, or conical in shape.

While this invention has been described with reference to certain specific embodiments as described and depicted within the figures, it will be recognized by those skilled in the art that many variations are possible with departing from the scope and spirit of this invention, and that the invention, as described by the claims, is intended to cover all changes and modifications of the invention which do not depart from the spirit of the invention.

What is claimed is:

1. A fuel filtration device comprising:
a. a filter press having at least 2 filter press plates;
b. micro-paper inserted between the filter press plates having a porosity of 0.3 to 10 microns; and
c. a compressor removably attached to one end of the filter press.

2. A fuel filtration device comprising:
a. an extendable inlet hose;
b. a pre-filter operatively connected to the extendable inlet hose;
c. an ozone chamber operatively connected to the pre-filter;
d. a transfer pump operatively connected to the ozone chamber;
e. a filter press operatively connected to the transfer pump;
f. at least 2 filter press plates operatively inserted into the filter press;
g. micro-paper between the filter press plates having a porosity of 0.3 to 10 microns;
h. a compressor removably attached to one end of the filter press wherein the compressor compresses the filter press plates or releases compression; and
i. an extendable outlet hose operatively connected to the filter press.

3. A method for filtering fuel from a fuel container comprising the steps of:
a. removing fuel and particulates from a container;
b. passing the fuel through a filter press containing filter press plates and 0.3 to 10 micron porous micro-paper; and
c. returning the fuel to the container.

4. The method of claim 3 further comprising the step of pre-filtering the fuel before passing the pre-filtered fuel through the filter press.

5. The fuel filtration device of claim 1 wherein 1 to 5 micro-papers are inserted between the filter press plates.

6. The compressor of claim 1 wherein the compressor is a screw mechanism.

7. The filter press plates of claim 1 wherein the filter press plates have a concave side and a convex side such that the filter press plates are inserted into the filter press with the concave side of one filter press plate positioned against the convex side of the adjacent filter press plate.

8. The filter press plates of claim 8 wherein the convex side of the filter press plate has a series of raised pillars positioned as to resemble a waffle or grid structure.

9. The fuel filtration device of claim 1 further comprising at least one storage spool.

10. The filter press plates of claim 1 having at least 1 inlet channel and at least 1 outlet channel.

11. The filter press of claim 1 further comprising a backplate, wherein the backplate contains a substantially flat surface which engages the compressor.

12. The fuel filtration device of claim 1 further comprising a filtration tank.

13. The fuel filtration device of claim 1 further comprising a pressure valve.

14. The fuel filtration device of claim 1 further comprising an overflow filter.

15. The fuel filtration device of claim 1 further comprising a floater chamber.

16. The pre-filter of claim 2 wherein the pre-filter contains a pre-filtering means for removing from the fuel particles greater than ½ cm.

17. The extendable inlet hose of claim 2 wherein the extendable inlet hose is made from flexible materials and is of a cylindrical, prismatic, conical or other similar shape.

18. The extendable outlet hose of claim 2 wherein the extendable outlet hose is made from flexible materials and is of a cylindrical, prismatic, conical or other similar shape.
